(19) United States
(12) Patent Application Publication
(10) Pub. No.: US 2011/0061871 A1
(43) Pub. Date: Mar. 17, 2011

(54) MANIFOLD STRUCTURE HAVING ADJUSTABLE BRACKETS

(76) Inventor: Sigvard Omvik, Moss (NO)

(21) Appl. No.: 12/992,155

(22) PCT Filed: May 12, 2009
(86) PCT No.: PCT/NO2009/000179

§ 371 Date: Nov. 11, 2010

(30) Foreign Application Priority Data
May 15, 2008 (NO) 20082232

(51) Int. Cl. E21B 29/12; F16L 3/08; B23P 11/00

(52) U.S. Cl. 166/360; 248/70; 29/525.01

(57) ABSTRACT

The invention relates to a manifold structure that includes a frame construction (1), a number of pipes (2), a pipe bend and possible valves, deployed in a pipe system having a number of pipe terminations projecting from the frame construction. The frame construction (1) is designed with a number of support brackets (5) for respective coupling parts associated with said pipe terminations. Each support bracket (5) is made as a separate, standardized unit that includes several securing means for releasable assembly to the frame construction, where each securing means is arranged for defined adjustability in height and lateral direction for adaption to a preinstalled pipe termination.

The present invention relates to a manifold structure including a frame construction, a number of pipes, pipe bends and possible valves, which are deployed in a pipe system having a number of pipe terminations projecting from the frame construction, which frame construction is provided with a number of support brackets for respective connector parts associated with said pipe terminations.

The invention also relates to a method for the manufacture of a manifold structure of the kind stated above.

Such manifold structures are designed to be placed on the sea bed and are to be connected to one or more Christmas trees for the production of oil and/or gas. The interconnecting operation takes place in that jumpers, or lines, are lowered from the surface toward connecting points on the manifold structure and the Christmas trees. The manifold structure is often constructed by a number of girders and braces suitably arranged in a more or less open frame construction which in turn can be set on a base located on the sea bed, for example a suction anchor or mud mat. The piping includes a number of headers, branch pipes, bends and valves.

It has been a problem with the production tolerances during the manufacture of such manifold structures. This needs to been seen in conjunction with the huge dimensions involved. The structures are frequently several tenths of meters long and support correspondingly long pipes having large dimensions, often several decimetres in diameter. The pipes and bends with their angles, are manufactured according to dimensioned drawings. The same apply for the body of the frame construction and associated support brackets. Generally 10-12, or more, support brackets are present per manifold structure. The support brackets are to form support and mount for respective pipe ends with their terminations. All factors above result in that a problem with the installation may occur if the components do not fit perfectly to each other.

Each pipe of the piping end in a pipe termination in the form of a connector flange which together with a connector porch (guide cone) forms a connector part which constitute the male part of a connector assembly. The male part is in one way or another secured to a support bracket on the frame construction. Until today each support bracket has been fixedly welded to the frame construction as if it was an integrated part thereof. This has resulted in problems if the pipes are not precisely manufactured with regard to pipe lengths and bend angles. By presumption, these parts are to fit precisely to the support brackets. When this has not been the case, it has been necessary to cut loose the bracket and have it displaced such that the bracket fits in with the connector flange, and then weld the bracket once again to the frame construction.

In addition, the support brackets have often been facing into the manifold structure, though not always. This has resulted in problems with the access during later interconnecting operations.

One object with the present invention has been to reduce the requirements to the tolerances in the manufacture of the main pipes. Thus it will be possible to cut down the use of time and reduce the manufacturing costs. In addition, deformations applied to the pipes due to manufacturing tolerances will not take place. At the same time, they will be easier to install without a need to use forces in order to force the pipes in place.

Another object has been to be able to perform parallel production of the frame construction and the components, for example the support brackets and the pipes. Thus a shorter manufacturing time during module construction is obtained.

Still another object has been to “standardize” components to be used on the frame construction such that these can be constructed and prepared independently of when the frame construction is constructed.

Still another object has been to improve the access to internal manifold structure during manufacturing thereof, such as good access during installation and assembly of pipes and bends.

The above stated objects are achieved according to the present invention in that a manifold structure of the introductory said kind is provided, which is distinguished in that each support bracket is made as a separate, standardized unit that includes several securing means for releasable assembly to the frame construction, which securing means are designed for defined adjustability in height and lateral direction for adaption to a preinstalled pipe termination.

It is to be understood that it is of material significance that the pipe up to the male part continuously needs to remain unloaded after the male part is fixedly secured—ergo no prevailing constraining forces subsequent to final assembly.

Preferably the securing means can include bolts/bolt connections. Bolts/bolt connections can extend through oblong apertures in order to obtain said adjustability.

According to the present invention a support bracket designed for installation on a manifold structure as stated above is also provided, where the support bracket is designed to support a connector part which retains a pipe end having a connector flange, which in particular is distinguished in that the support bracket includes several securing means for releasable installation to the frame construction, which securing means are designed for defined adjustability in height and lateral direction for adaption to a preinstalled pipe spool having said connector flange.

In accordance with the present invention a method of the introductory said kind is also provided, which is distinguished in that the piping firstly is installed in place within the frame construction and having pipe terminations projecting outwards from the frame construction and directed upwards, that a support bracket is placed at respective pipe terminations and coarse adjusted relative to the pipe terminations, that a connector porch is installed over respective connector flanges, that each connector porch is fixedly bolted to an associated connector flange and then welded to an associated support bracket, said support bracket subsequently being fine adjusted and finally fixed to the frame construction.

Other and further objects, features and advantages will appear from the following description of preferred embodiments of the invention, which is given for the purpose of description, and given in context with the appended drawings where:

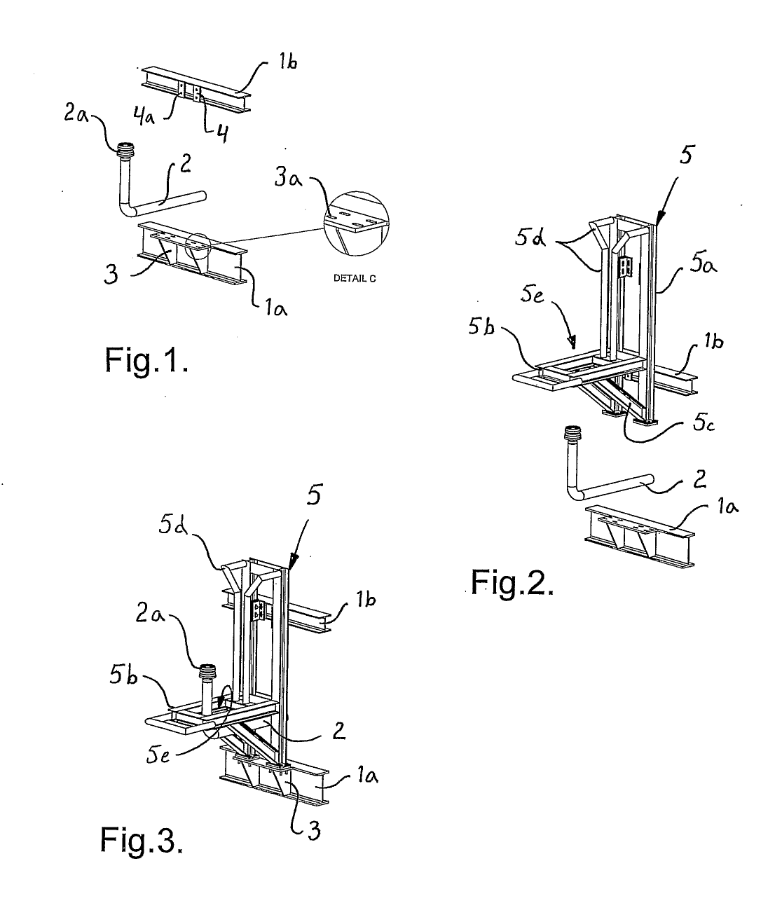

FIG. 1 shows in perspective view a cut out of a top frame and bottom frame of the frame construction of a manifold structure, including a detailed view C,

FIG. 2 shows in perspective view a support bracket which is lowered for installation on the frame construction of the manifold structure according to the invention,

FIG. 3 shows in perspective view the support bracket completely landed on the frame construction of the manifold structure according to the invention,

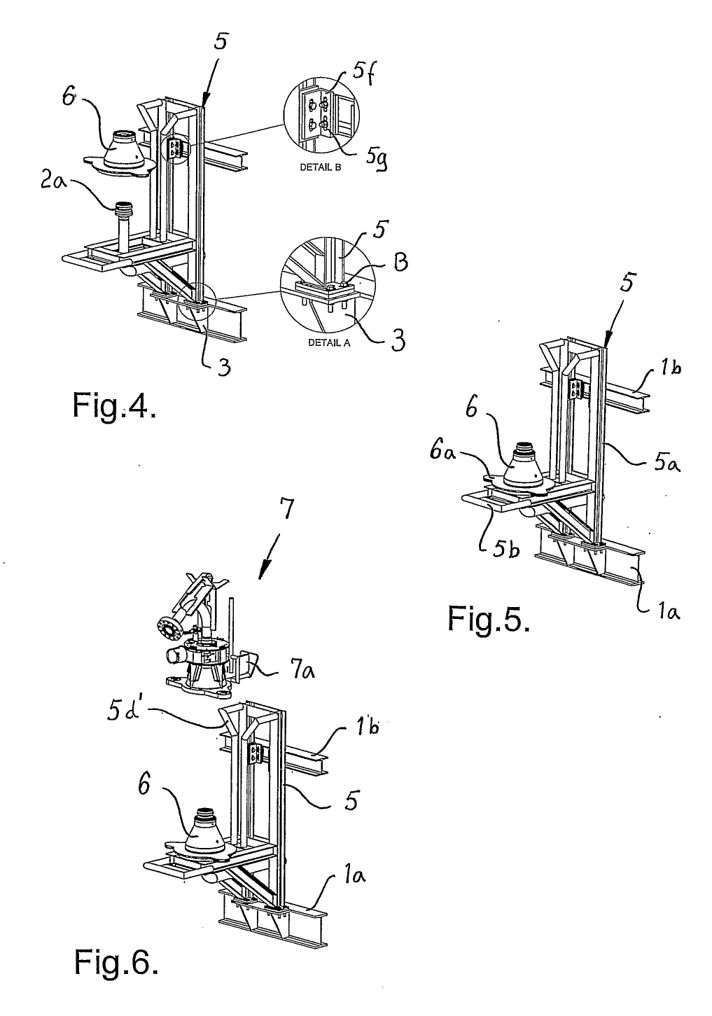

FIG. 4 shows in perspective view a connector porch which is about to be landed on the support bracket of the frame construction, including two detailed views A and B,

FIG. 5 shows in perspective view the connector porch completely landed on the support bracket of the frame construction of the manifold structure according to the invention,

FIG. 6 shows in perspective view installation of a VCM on the connector porch on the support bracket on the frame construction of the manifold structure according to the invention,

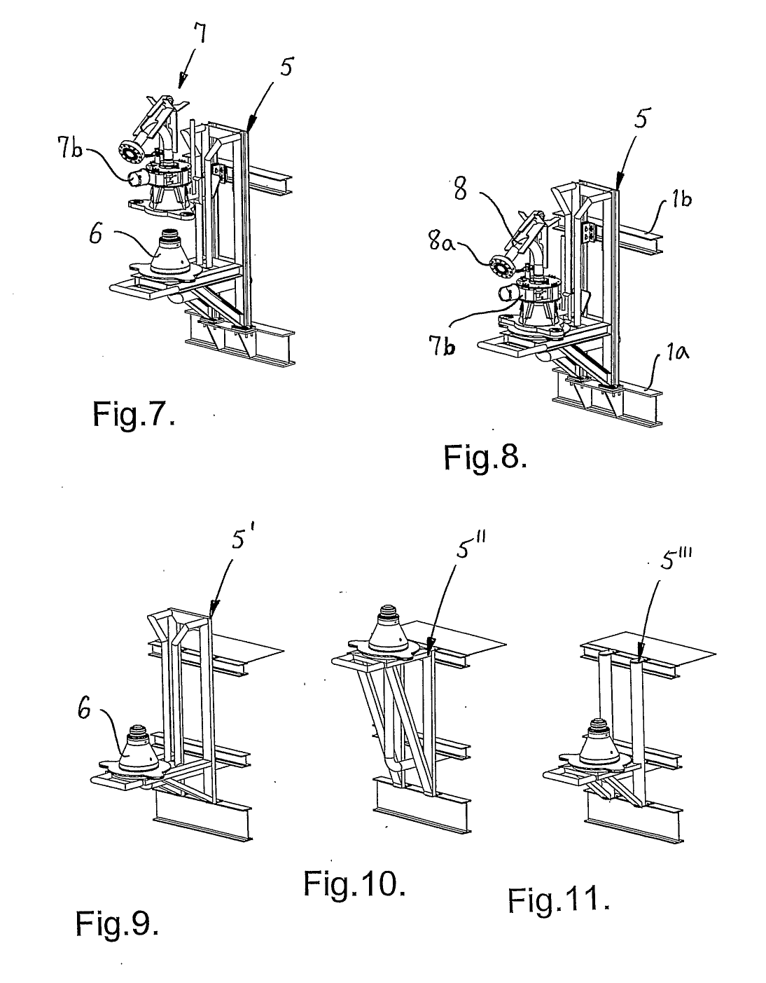

FIG. 7 shows in perspective view when the VCM enters the support bracket on the frame construction,

FIG. 8 shows in perspective view the VCM completely landed on the support bracket on the frame construction,

FIG. 9-11 show a variety of alternative embodiments of support brackets according to the invention.

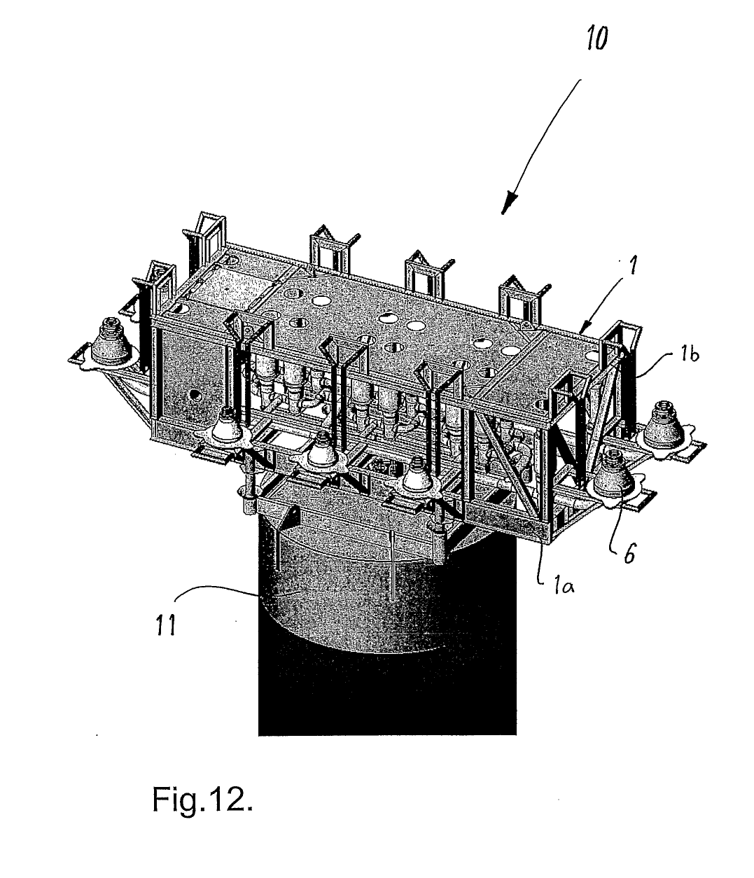

FIG. 12 shows a typical manifold structure with support brackets according to the invention.

A typical and complete manifold structure 10 is illustrated in FIG. 12 and can be conferred to as the FIGS. 1-11 are described. This is to ease the understanding of the invention and be able to recognize the interrelation where the individual parts and components are to be placed within the manifold structure and in relation to each other. The shown manifold structure 10 is fixed to a suction anchor 11 which in turn is placed on the sea bed.

Reference is firstly made to FIG. 1 which shows a partial view of a manifold structure, more precisely a bottom part 1a and a top part 1b of the frame construction 1 of the manifold structure 10. Then frame construction 1 is of substantial dimensions, often several tenths of meters long. An angled pipe 2, or a bend, having a connector flange 2a is illustrated as located in the frame construction 1. Further, the bottom part 1a has a bracket structure 3 with oblong apertures 3a designed for later adjustable installation of components on the bracket structure 3. The top part 1b has a corresponding support structure 4 having apertures 4a designed for later installation of said components on the support structure 4.

FIG. 2 shows a support bracket 5 which is about to be landed on the frame construction 1. The support bracket 5 has a substantially vertically extending back structure 5a, one substantially horizontally extending support structure 5b, inclined braces 5c and a guiding structure 5d. Moreover the support structure 5b has a central aperture 5e for receipt of the bend 2.

FIG. 3 shows the support bracket 5 landed on the bracket structure 3 and rests thereon. The bend 2 fits through the aperture 5e in the support structure 5b and in turn, the connector flange 2a extends upwards from the plane of the support structure 5b and stands ready to receive a mating component.

FIG. 4 shows such a component in the form of a connector porch 6 (guide cone) which is to be lowered down over the connector flange 2a. Further, a detailed view A in enlarged scale is shown that illustrates the lower mount between the support bracket 5 and the support structure 3 on the bottom part 1a. A number of bolts B are used to secure the parts together. Oblong recesses in the parts enable the parts to be adjusted in respect of each other in the horizontal plane.

The detailed view B in FIG. 4 shows an upper securing means 5f on the back structure 5a in enlarged scale. The securing means 5f has oblong apertures 5g to be able to make height adjustment. If height adjustment is necessary, shims or spacers can be installed between respective flange parts on the support bracket 5 and the bracket structure 3, i.e. on that spot depicted in detailed view A in FIG. 4.

FIG. 5 shows the connector porch 6 completely landed onto the support structure 5b. The connector porch 6 has a bottom plate 6a which provides some freedom of motion in the horizontal plane to obtain correct position in respect of the connector flange 2a. The bottom plate 6a rests against the top surface of the support structure 5b.

FIG. 6 shows the first step in the finishing phase during installation of a vertical connector module 7 (VCM) onto the connector porch 6 which in turn is arranged on the support bracket 5 on the frame construction 1. The connector module 7 is landed from above and positioned such that the female part stands right above the connector porch 6. The connector porch 6 thus constitutes the male part. The connector module 7 has guiding means 7a which are design for cooperation with the guide structure 5d which is arranged on the back structure 5a of the support bracket 5. During the lowering operation the guiding means 7a guides the connector module 7 against the connector porch 6 by means of the guiding structure 5d. In the upper part of the guiding means 5d, inclined faces 5d′ are provided to ease the introduction of the guiding means 7a into the guiding structure 5a.

FIG. 7 shows the next step of the finishing phase. The connector module 7 has engaged the guiding structure 5d via the guiding means 7a and is guided further into place toward the connector porch 6 on the support bracket 5. The connector module 7 includes a clamp connector 7b which makes up the final connection between the flanges.

FIG. 8 shows the finished installation of the connector module 7 on the connector porch 6 on the support bracket 5 on the frame construction 1. The connector module 7 includes a pipe bend 8 having a connector flange 8a which is used for later connection of a pipe line which is tied in toward this flange 8a.

FIGS. 9 to 11 show three variants 5′; 5″; 5′″ among many possible embodiments of a support bracket according to the present invention.

The way in which the entire manifold structure is manufactured will now be described with reference to FIGS. 1-8. We assume that a per se traditional frame construction already has been manufactured and prepared for further construction, installation and assembly.

Firstly the piping (pipe system) is installed in place in the frame construction. All external connecting points in the form of pipe terminations project outwards from the body of the frame construction. The pipe terminations are further such designed that they are pointing upwards. Subsequently each bracket is placed over respective pipe terminations. Each bracket is coarse adjusted relative to the associated pipe termination.

Then a connector porch is placed over respective connector flange. Each connector porch is in turn bolted in place on corresponding connector flange. Then the connector porch is welded to its associated support bracket. Finally each bracket is fine adjusted and eventually fixed by means of bolts and nuts to the frame construction.

Thus, exactly this that the pipes are installed totally without stresses or loads is achieved.

1. A manifold structure comprising:
a frame construction;
a number of pipes;
pipe bends and possible valves deployed in a pipe system having a number of pipe terminations projecting from the frame construction;
wherein the frame construction is designed with a number of support brackets for respective connector parts associated with said number of pipe terminations;
wherein each support bracket is made as a separate, standardized unit that includes a plurality securing means for releasable installation to the frame construction; and
wherein the plurality of securing means are designed for confined adjustability in height and lateral direction for adaption to a preinstalled pipe termination.

2. The manifold according to claim 1, wherein the plurality of securing means comprise at least one of bolts and bolt connections.

3. The manifold according to claim 2, wherein the plurality of securing means comprise at least one of bolts and bolt connections that extend through oblong apertures for said adjustability.

4. A support bracket designed for installation to the manifold structure as claimed in claim 1, wherein the support bracket is designed to support a connector part which retains a pipe end having a connector flange, wherein the support bracket includes several securing means for releasable installation to the frame construction, wherein the securing means are designed for confined adjustability in height and lateral direction for adaption to a preinstalled pipe spool having said connector flange.

5. A method to manufacture a manifold structure of claim 1, wherein:
installing the piping in place within the frame construction by having the pipe terminations projecting outwards from the frame construction and directed upwards;
placing a support bracket at respective pipe terminations and coarse adjusting the support bracket relative to said pipe termination;
installing a connector porch over respective connector flanges;
bolting each connector porch to an associated connector flange; and
wherein said each connector porch is welded to an associated support bracket, said support bracket is subsequently fine adjusted and fixed to the frame construction.
